(19) United States
(12) Patent Application Publication
(10) Pub. No.: US 2015/0260346 A1
(43) Pub. Date: Sep. 17, 2015

(54) GAS DISTRIBUTION SYSTEM WITH ROTARY CONTROL MEMBER PROTECTED BY A PROJECTING RIM CARRYING A READING WINDOW

(71) Applicant: L'Air Liquide, Société Anonyme pour I'Etude et I'Exploitation des Procédés Georges Claude, Paris (FR)

(72) Inventors: Renaud LIGONESCHE, Herblay (FR); Chiara Tarantello, Puteaux (FR)

(21) Appl. No.: 14/642,232

(22) Filed: Mar. 9, 2015

(30) Foreign Application Priority Data
Mar. 12, 2014 (FR) 1452042

(51) Int. Cl. F17C 13/06; F17C 1/00; F17C 13/02

(52) U.S. Cl. CPC F17C 13/06; F17C 13/02; F17C 1/00

(57) ABSTRACT

The invention relates to a gas distribution system including a gas container, a valve assembly and a protective cap arranged around said valve assembly. The valve assembly includes a rotary control member, which can be manoeuvred by a user, cooperating with a gas passage control system for controlling the passage of gas when it is manoeuvred by a user. The protective cap including an opening in which the rotary control member is housed, which is bordered by a projecting rim projecting away from the external lateral surface of the protective cap. The projecting rim includes a cut-out forming a reading window coming to be positioned facing at least one marker carried by the peripheral region of the rotary control member so as to enable a user to view said at least one marker through the reading window.

### CROSS REFERENCE TO RELATED APPLICATIONS

This application claims the benefit of priority under 35 U.S.C. §119 (a) and (b) to French Patent Application No. 1452042 filed Mar. 12, 2014, the entire contents of which are incorporated herein by reference.

### BACKGROUND

The invention relates to a gas distribution system including a gas container, such as a gas bottle, in particular for medical gas; a valve assembly fixed to the gas bottle, said valve assembly optionally having an integrated pressure regulator system and including a rotary handwheel for releasing the gas; and a protective cap arranged around the valve assembly to protect it from impact and dirt.

Industrial and medical gases are routinely packaged at high pressure in gas containers, typically gas bottles, equipped with a valve assembly, optionally with an integrated pressure regulator, namely a basic open/closed type valve or a valve with integrated pressure regulator, also known as an RDI valve, enabling control of the flow rate and pressure of the gas delivered.

In order to protect this valve assembly, it is common practice to arrange around said valve assembly a protective cap forming a protective shell around the body of the valve. Such a cap is routinely referred to as a “hat”. Caps of this type are notably described in the documents EP-A-629812, DE-A-10057469, US-A-2004/020793 and EP-A-2586481.

The circulation of the gas in the valve assembly is usually controlled by means of a gas passage control system arranged on the internal gas passage that fluidically connects the gas container to an outlet orifice of the valve assembly, said gas passage control system generally cooperating with a control member manoeuvrable by a user, for example a rotary handwheel or a lever.

Such a gas passage control system conventionally includes a mobile element, such as a rotary disk, carrying calibrated orifices having increasing dimensions corresponding to increasing gas flow rate values on which acts the control member manoeuvred by a user so as to free all or part of the gas passage and thus allow its circulation in the valve assembly in the direction from the gas inlet orifice to the gas outlet orifice, or conversely, to lock the gas passage to prevent any circulation and therefore release of gas.

Now, the existing control members have disadvantages.

Thus the pivoting control levers are not very precise and as a general rule they allow only all or nothing type release of the gas, that is to say with no possibility of precisely adjusting the required gas flow rate.

Similarly, the existing rotary handwheels are generally not very precise and cause problems of flow rate choice reliability because:
they include no graduations or markers enabling reliable and precise knowledge or adjustment of the flow rate of gas required and/or delivered, or
they include coarse markers, which are therefore extremely imprecise and relatively unreliable, or
they include a marker or an indicator, such as a line or an arrow, that comes to be positioned on a more or less precise scale of graduations carried by the valve or the protective cap arranged around the valve. Now, in this case, problems arise of precision, reliability and the complication of the overall architecture of the system. Moreover, this also generates problems during assembly because the marker of the rotary handwheel must be precisely positioned opposite the graduations of the valve or the cap, which leads to losses of productivity during assembly and maintenance phases, and leads to poor adjustment or loss of adjustment thereafter. Moreover, the graduated scales may over time become detached from their support, making it impossible to know and to adjust precisely the gas flow rate etc.

Accordingly, each of the documents EP-A-2810124 and WO-A-2008/149312 describes a gas container equipped with a valve assembly and a protective cap arranged around said valve assembly so as to protect it against impact or the like. The protective cap includes larges openings providing access to the valve assembly. A rotary handwheel arranged on the valve assembly and mobile over at least one complete turn enables control of the pressure or the flow rate of the gas. The rotary handwheel carries graduations corresponding to flow rates or pressures. According to EP-A-2810124, access to the handwheel and reading of the graduations that it carries are effected through one of the openings of the cap, although the reference marker is not clearly indicated, while according to WO-A-2008/149312, the handwheel is arranged so as to project relative to the external surface of the cap and the adjustment is effected coarsely relative to the gas outlet connector that serves as a reference marker.

In view of this, the problem that arises is to improve the selection of the gas flow rate by the user and the reading of the gas flow rate delivered by a gas distribution valve assembly arranged on a gas container, such as a gas bottle, equipped with a protective cap protecting the valve assembly, whilst avoiding the disadvantages mentioned above.

### SUMMARY

The solution in accordance with the invention is then a gas distribution system including a gas container, a valve assembly and a protective cap arranged around said valve assembly, wherein:
the gas distribution valve assembly includes a rotary control member, manoeuvrable by a user, cooperating with a gas flow rate control system, that is to say a gas passage control system for controlling the gas flow rate delivered by the valve assembly when it is manoeuvred by the user, said rotary control member including a peripheral region including markers angularly offset relative to the rotation axis AA of the rotary control member, said markers each corresponding to a given gas flow rate, and
the protective cap including an opening in which the rotary control member is housed,

characterized in that the opening is at least in part bordered by a projecting rim projecting away from the external lateral surface of the protective cap, said projecting rim including a cut-out forming a reading window coming to be positioned facing a marker carried by the peripheral region of the rotary control member so as to enable a user to view said marker through the reading window.

The gas distribution system in accordance with the invention may include one or more of the following technical features, as appropriate:
the projecting rim includes a cut-out forming a reading window coming to be positioned facing a single marker carried by the peripheral region of the rotary control member so as to enable a user to view completely only said marker through said reading window. In other words, a single and unique marker appears entirely, that is to say in a non-truncated manner, within the cut-out.
the cut-out carried by the projecting rim is a notch.
the cut-out carried by the projecting rim is a U-shaped or V-shaped notch.
the cut-out forms a notch extending into the projecting rim.
the cut-out forms a notch extending to a depth between 0.5 and 5 cm in the projecting rim.
the projecting rim has a maximum width between 0.8 and 10 cm, preferably less than 7 cm.
the gas distribution valve assembly further includes a gas inlet orifice through which a gas can enter the valve body, a gas outlet orifice through which the gas can leave the valve body, and a first internal gas passage fluidically connecting the gas inlet orifice to the gas outlet orifice.
the rotary control member cooperates with the gas flow rate control system, when it is manoeuvred by the user, to control the passage of gas in the first internal gas passage in the direction from the gas inlet orifice to the gas outlet orifice.
the rotary control member is mobile about a rotation axis and includes a central region including the rotation axis AA and holding means enabling the user to grip the rotary control member between their fingers and to impart to it a rotary movement about said rotation axis AA.
the peripheral region of the rotary control member is situated at the periphery of the central region.
the peripheral region of the rotary control member carrying the markers forms at least a part of a ring, preferably a complete or quasi-complete ring.
the markers of the rotary control member include increasing flow rate indications.
the markers of the rotary control member include increasing flow rate indications between 0 and 40 l/min, preferably between 0 and 25 l/min.
the holding means carried by the central region of the rotary control member include one or more upstanding elements and/or housings.
the central region and the peripheral region of the rotary control member are fastened to each other, preferably formed in one piece, for example by moulding.
the gas outlet orifice is carried by a gas outlet connector, the rotary control member being mobile in rotation about said gas outlet connector.
the gas flow rate control system includes a mobile element carrying calibrated orifices having increasing dimensions corresponding to increasing gas flow rate values.
the mobile element of the gas flow rate control system is a rotary disk. This rotary disk is pierced with calibrated orifices.
the rotary control member cooperates in rotation with the mobile element of the gas flow rate control system to control the gas flow rate delivered by the valve assembly.
the rotary control member is a rotary handwheel.
the valve body includes a gas pressure regulator system arranged between the site of fluidic connection of the first and second internal gas passages and the gas outlet orifice. In accordance with this embodiment, it is therefore a valve with integrated pressure regulator or RDI valve.
the pressure regulator system includes a high-pressure chamber, a valve and a valve seat.
the pressure gauge is an analogue pressure gauge or a pressure gauge with a digital read-out, also referred to as an “electronic” or “digital” pressure gauge.
the rotary control member is arranged coaxially with and around the gas outlet connector carrying the gas outlet orifice.
the valve body is of copper alloy, brass, steel or stainless steel.
the fixing system enabling fixing of the lower part of the valve body to a gas container includes a thread arranged on the external periphery of a cylindrical or conical expansion located at the level of the lower part of the valve body. The thread carried by the cylindrical or conical expansion is fixed by screwing it into or onto a reciprocal internal/external thread arranged at the level of the outlet orifice of the gas container, in particular at the level of the neck of a gas bottle.
the body of the valve further includes a filling connector including a filling orifice with an internal filling valve enabling introduction of the gas at high pressure into the gas container equipped with said valve body, when the latter is empty, that is to say when it contains no gas or no longer contains gas.
the protective cap includes an opening in which the rotary control member is housed, said opening being arranged in the front face of the protective cap.
the projecting rim includes one or more markings symbolizing the direction of opening or of closing of the valve, i.e. the direction of rotation of the handwheel enabling release of the gas or conversely interruption of distribution of the gas.
the projecting rim includes one or more markings symbolizing at least one “arrow”, a “+” sign or a “−” sign, or any other symbol.
the gas container is a gas bottle, also known as a cylinder.
the protective cap including an opening arranged at the level of the upper part of the protective cap and in which the pressure gauge is housed, that is to say the opening is formed through the wall of the cap.
the protective cap includes a plane surface at the level of its upper part, the opening including the pressure gauge being arranged in said plane surface.
the plane surface forms a face oblique relative to the vertical axis of the cap.
the cap is in polymer material, for example in plastic, in composite, or in metal or metal alloy, for example in steel, in cast iron, in aluminium or an aluminium alloy.
the cap is in plastic material, such as PVC, PE, PET, PP, PMMA, PU, PA etc.
the protective cap includes a carrying handle, preferably a carrying handle connected to the cap by one or more support-uprights.
the carrying handle is arranged on the cap so that the pressure gauge is positioned substantially between the carrying handle and the valve assembly carrying said pressure gauge.
the protective cap further includes an attachment device enabling the system to be attached to a support, in particular a bed rail, a stretcher etc.
the protective cap further includes an attachment device adapted to enable attachment of the assembly to a support, in particular a tubular or like support.
the protective cap further includes a pivoting attachment device.
the carrying handle and/or the support-uprights are formed of a rigid material chosen from polymers and metals or metal alloys.
the carrying handle is globally elongate. Its length is typically between 5 and 20 cm, preferably between 6 and 15 cm.
the carrying handle surmounts the cap body.
the carrying handle is horizontal or quasi-horizontal and perpendicular to the axis of the cap.
the gas bottle has a size between 10 and 150 cm.
the gas bottle contains 0.5 to 20 litres (water equivalent capacity).
the gas bottle has a hollow cylindrical body and includes a neck carrying a gas outlet orifice at the level of which the valve assembly is fixed, preferably by screwing.
the gas bottle contains a gas or gas mixture, preferably a gas or gas mixture conforming to the specifications of the medical field (pharmacopoeia).
the gas bottle contains a gas or gas mixture chosen from oxygen, air, an N₂O/O₂ mixture, a He/O₂ mixture, an NO/nitrogen mixture or any other gas or gas mixture.
the bottle is in steel, in an aluminium alloy or in composite material.
the bottle contains gas at a pressure up to approximately 350 bar.

The invention also relates to a use of a gas distribution system in accordance with the invention to store or distribute a gas or gas mixture, in particular of oxygen, air, N₂O/O₂, He/O₂ or NO/nitrogen type.

### BRIEF DESCRIPTION OF THE DRAWINGS

The invention will now be better understood thanks to the following detailed description given by way of nonlimiting illustration with reference to the appended figures in which:

FIG. 1 represents a ¾ front view of one embodiment of a bottle/valve assembly/cap in accordance with the invention,

FIG. 2 is a left-hand side view of the valve assembly of the system in accordance with the invention from FIG. 1,

FIG. 3 is a front view of the rotary control member equipping the valve assembly from FIGS. 1 and 2, and

FIG. 4 is a sectional view showing diagrammatically the operation of the valve assembly from FIGS. 1 and 2.

### DESCRIPTION OF PREFERRED EMBODIMENTS

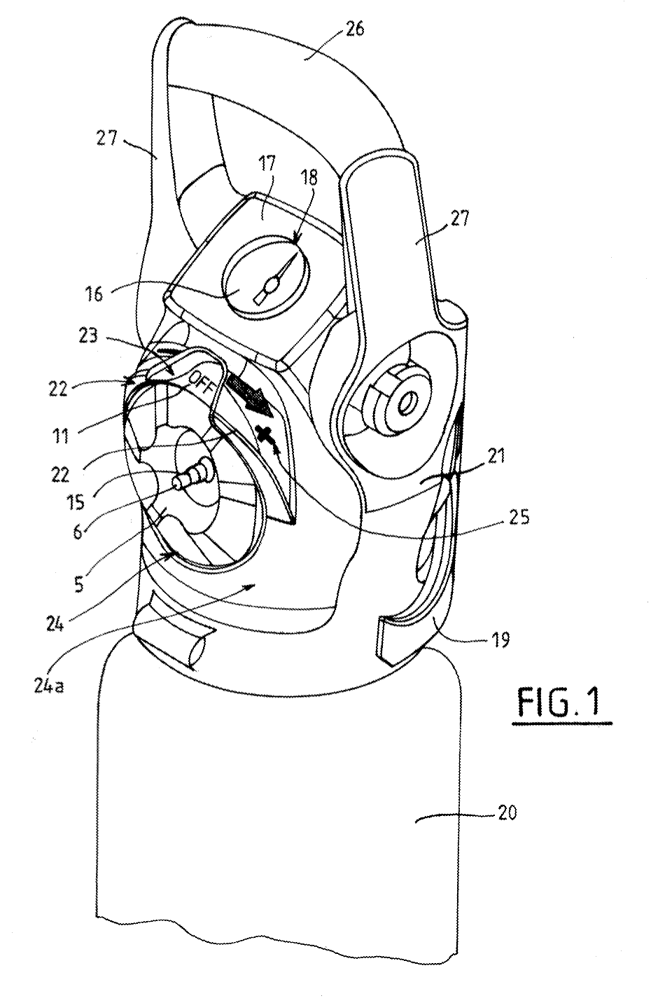

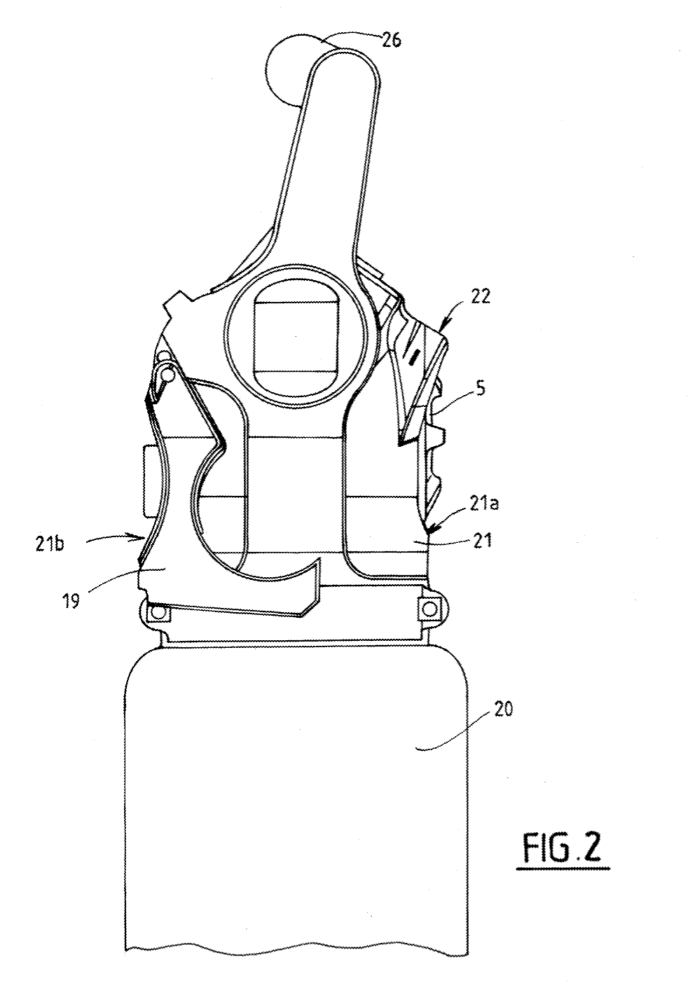

FIGS. 1 and 2 represent one embodiment of a gas distribution system in accordance with the invention including a rigid protective cap 21, routinely referred to as a “hat”, arranged around a valve assembly 1 (not entirely visible), namely a valve assembly optionally with an integrated pressure regulator, itself fixed to the neck of a gas bottle 20, said protective cap 21 being provided with a carrying handle 26 surmounting the cap body. The protective cap 21 makes it possible to protect the valve assembly 1 from impacts.

The gas bottle 20 typically has a cylindrical steel body and a size between 10 and 150 cm and a capacity of 0.5 to 20 litres (in water equivalent).

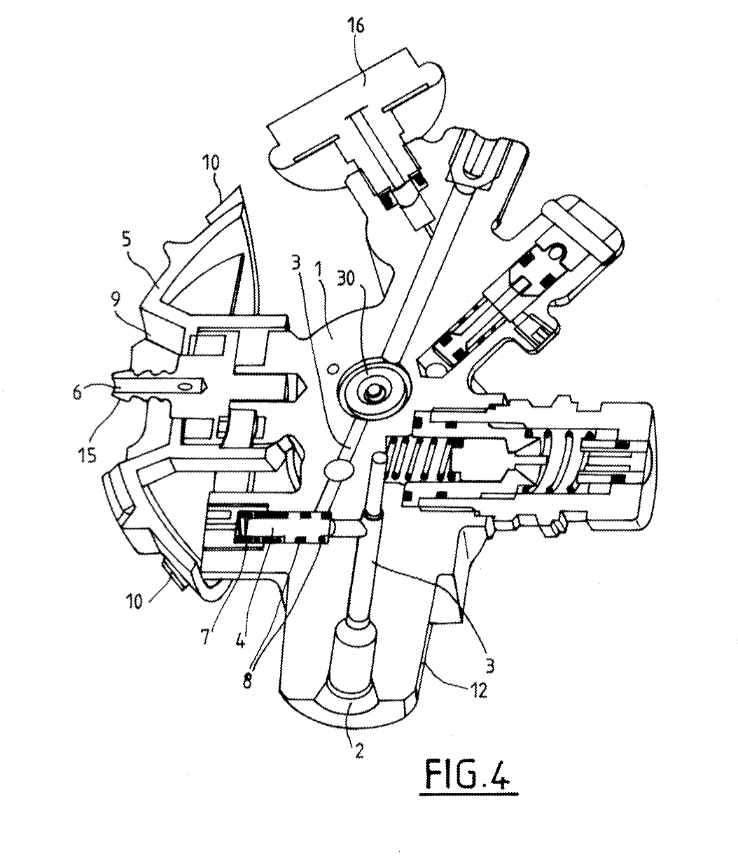

The fixing around the valve assembly 1 on the neck of the gas bottle 20 is effected by screwing, via reciprocal threads carried by the internal surface of the neck of the bottle 20, on the one hand, and the external surface of a substantially cylindrical or conical expansion 12, situated at the base of the valve body 1 and carrying the gas inlet orifice 2, as shown in FIG. 4, on the other hand.

To be more precise, the protective cap 1 includes a cap body forming a protective shell around an internal volume sized to receive the valve assembly 1 and a carrying handle 26 designed to be held in the hand by a user.

The cap body 21 is typically in a polymer and/or metal type material, preferably in plastic material, such as PVC, PE, PET, PP, PMMA, PU, PA etc. For its part the carrying handle 26 is formed of a rigid material, such as a polymer or a metal or metal alloy, and is carried by one or more support-uprights 27 mechanically connecting the cap body to the carrying handle 26. The carrying handle 26 is generally arranged horizontally, that is to say perpendicularly or quasi-perpendicularly relative to the vertical axis of the bottle 20 and the cap 21. The carrying handle 26 has an elongate shape, whether it is straight or curved, typically a length less than 20 cm, typically from 6 to 15 cm.

One or more support-uprights 27 are fixed to the carrying handle 26 so as to enable a user to transport easily the assembly comprising the cap 21, the valve 1 and the bottle 20 by means of said carrying handle 26. The support-uprights 27 may be formed of a plastic material, like the cap body 21, but also in aluminium alloy or any other metal. They may be fixed to the handle 26 by screwing or welding, for example.

The protective cap 21 also includes openings providing access to the valve assembly 1 situated in the internal volume of the cap body.

In particular, a first opening 24 is arranged at the level of the front face 21a of the protective cap 21, inside which is housed a rotary control member 5, such as a rotary handwheel, that can be manoeuvred by the user.

In the conventional way, this rotary control member 5 cooperates with a gas passage control system, when it is manoeuvred by the user, to control the passage of gas, that is to say to allow or to prevent it leaving the valve assembly 1. In other words, by acting on the rotary control member 5, the user can adjust or regulate the gas flow rate delivered by the valve assembly 1, or even totally interrupt it. The rotary control member 5 in accordance with the present invention is described in detail hereinafter.

The protective cap 21 further includes a second opening 18 in which is housed a pressure gauge 16, either an analogue pressure gauge or an electronic pressure gauge. To be more precise, the protective cap 21 includes a plane surface 17 situated at the top of the cap, inside which the second opening 18 is arranged. The plane surface 17 in fact constitutes a face that is oblique relative to the vertical axis of the bottle 20. Such an arrangement of the pressure gauge 16 at a high position on the valve assembly 1 and on the front 21a of the cap makes it possible considerably to facilitate reading the pressure delivered by the pressure gauge 16 and therefore preventing reading errors.

Moreover, the protective cap 21 includes other openings providing access to filling connectors, pressurized gas outlet connectors etc. situated laterally or on the rear face 21b of the body of the cap 21, as can be seen in FIGS. 1 and 2.

In the embodiment from FIGS. 1 and 2, the rotary handwheel 5 is arranged around the gas outlet connector 15 carrying the gas outlet orifice 6 used to draw off the gas stored in the bottle 20, that is to say in a coaxial manner.

Moreover, in order to enable the bottle/valve assembly/cap assembly to be attached or tied to a support, such as a hospital bed rail or stretcher, the protective cap 21 includes, on the side of its rear face 21b, an attachment device 19 pivoting between a completely folded or “rest” position (shown diagrammatically in FIGS. 1 and 2), that is to say the position adopted by the attachment device 19 when it is stowed and in contact or quasi-contact with the body of the cap 21, and a totally unfolded or “attachment” position (not shown), that is to say the position adopted by the attachment device 19 when it is completely deployed and can be attached to a support, such as a bed rail or the like.

As shown in detail in FIG. 4, the gas distribution valve assembly in accordance with the invention includes a valve body 1 including a fixing system 12, such as an expansion of the body forming a cylindrical or conical part carrying a peripheral thread, enabling fixing of the valve assembly 1 to the neck of the bottle 20, which neck carries a complementary thread. This threaded cylindrical or conical part 12 also carries the gas inlet orifice 2 through which a gas under pressure coming from the bottle 20 can enter the valve body 1 and then be routed therein via an internal gas passage 3 to the gas outlet orifice 6 through which the gas can leave the valve body 1.

In other words, the internal gas passage 3 fluidically connects the gas inlet orifice 2 to the gas outlet orifice 6 carried by the outlet connector 15.

Moreover, as shown in FIG. 4, the valve assembly 1 also includes a gas flow rate control system, also referred to as the gas passage control system, arranged on the internal gas passage 3, cooperating with the control member 5, namely a rotary handwheel here that can be manoeuvred by the user, to control the passage of gas in the internal gas passage 3, that is to say to allow or conversely to prevent any circulation of gas in said passage 3, in the direction from the gas inlet orifice 2 to the gas outlet orifice 6 carried by the outlet connector 15.

The flow rate control system typically includes an element pierced with calibrated orifices, the handwheel, as appropriate, causing either a calibrated orifice corresponding to the required flow rate to cooperate with a fixed passage orifice or a mobile passage orifice to cooperate with the calibrated orifice corresponding to the required flow rate. Such an arrangement is conventional and known to the person skilled in the art.

The element pierced with calibrated orifices is preferably a metal disk that is mobile in rotation and through which pass calibrated orifices. The orifices have different sizes, i.e. increasing sizes, each size corresponding to a given flow rate value. This disk is mobile in rotation and driven by the handwheel 5.

Broadly speaking, when the user wishes to impart a rotation movement to the handwheel 5, they will act directly or indirectly on the metal disk mobile in rotation and through which the calibrated orifices pass so as to enable the passage of a greater or lesser flow of gas in the gas passage of the valve assembly in the direction of the outlet orifice 6, said flow rate corresponding to the opening defined by the calibrated orifice through which the flow of gas passes.

Moreover, the valve assembly also incorporates a valve 4 mobile in translation, one or more seals 8, such as O-rings, and at least on return spring 7. The valve 4 is a residual pressure valve intended to maintain a positive pressure at all times in the bottle. This valve 4 functions autonomously, without any actuation of the handwheel.

The valve body 1 further includes one or more internal gas conduits as can be seen in FIG. 4 notably used to fill the bottle 20 when it is empty, as a pressure take-off for the pressure gauge 16 etc.

In the embodiment shown in the figures, the valve assembly is of the RDI type, that is to say it includes a gas pressure regulator system 30 arranged between the gas flow rate control system and the gas outlet orifice 6 so as to reduce the pressure of the gas at high pressure coming from the bottle 20 to a lower pressure value delivered by the outlet orifice 6, for example a pressure reduction from a high pressure greater than 100 bar to a low pressure lower than 20 bar abs. To this end, in the conventional way, a pressure regulator system 30 is provided including a high-pressure chamber, a pressure regulator valve and a valve seat. The final pressure may be of adjustable or fixed value.

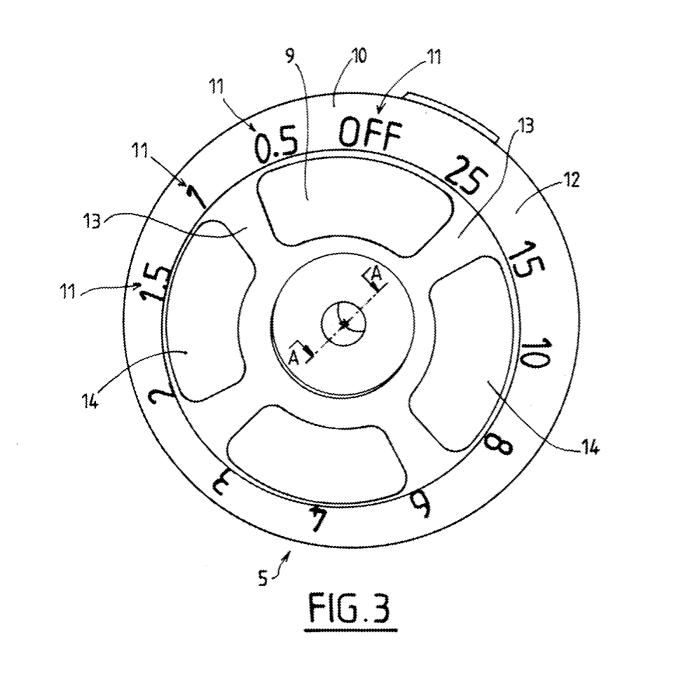

As shown diagrammatically in FIGS. 3 and 4, the rotary control member 5 that cooperates with the gas flow rate control system arranged on the first internal gas passage 3 is mobile in rotation about a rotation axis AA.

This rotary control member 5, such as a rotary handwheel, includes a central region 9 including the rotation axis AA and a peripheral region 10 situated at the periphery of the central region 9, said central region 9 and said peripheral region 10 being fastened together.

To be more precise, the central region 9 includes holding means 13, 14 enabling the user to grip the rotary control member 5 between their fingers and to impart to it a movement of rotation about the rotation axis AA.

The central region 9 of the control member 5 further includes a central orifice within which passes the outlet connector 15 carrying the outlet orifice 6. The control member 5 is therefore free to rotate about said outlet connector 15.

Moreover, the peripheral region 10 including markers 11 angularly offset relative to the axis AA, said markers 11 each corresponding to a given gas flow rate.

In FIG. 3, the markers 11 are in order in a ring 12 situated over the complete periphery of the central region 9 and indicating increasing flow rate values.

Accordingly, one of the markers 11 corresponds to a position of the handwheel 5 in which the gas is cut off, that is to say the valve 1 does not deliver gas (i.e. flow rate=0 l/min), namely the “OFF” marker.

The other markers 11 correspond to positions of the handwheel 5 in which the gas is delivered at different flow rates, namely flow rates of 0.5, 1, 1.5, 2, 3, 4, 6, 8, 10, 15 and 251/min of gas.

The markers 11 may be etched, printed, stuck on or applied in any other appropriate technical manner to the ring 12.

Similar, the markers 11 may comprise digits, letters or any other type of marking.

Moreover, the holding means 13, 14 carried by the central region 9 of the rotary handwheel 5 here comprise upstanding elements 13 and housings 14 so as to constitute grips for the user enabling them to impart to said handwheel 5 a movement in rotation in the direction of the hands of a clock (i.e. the clockwise direction) or in the opposite direction to the hands of a clock (i.e. the counterclockwise direction). Of course, the holding means 13, 14 can take other forms.

As a general rule, the central region 9 and the peripheral region 10 are fastened to each other and preferably formed in one piece, for example by moulding or by bonding them together.

The rotary handwheel 5 is preferably made of plastic material, such as PVC, PE, PET, PP, PMMA, PU, PA etc. but can also consist of an aluminium alloy or any other metal, or even a combination of materials, for example plastic materials and metal.

At least a part of the rotary handwheel 5 is preferably made of a rigid material covered with a flexible material having a Shore hardness between 0 and 95, for example a coating formed of a paint giving a so-called “soft touch” effect (i.e. feeling soft and silky to the touch) in order to increase the comfort of use for the user, or a coating formed of an overmolded layer of an elastomer material, silicone or the like.

As a general rule, when the user imparts a rotation movement to the handwheel 5, the latter will act directly or indirectly on the mobile valve 4 so as to allow the greater or lesser flow rate of gas to pass in the gas passage 3 in the direction of the outlet orifice 6, said delivered flow rate corresponding to one of the flow rate values carried by the ring 12 of the handwheel 5.

As already stated, the protective cap 21 includes an opening 24 in its front face 21a in which the rotary control member 5 is housed.

As can be seen in FIG. 1, this opening 24 is in part bordered by a projecting rim 22 projecting away from the external surface of the front face 21a of the protective cap 21, that is to say in the manner of a cap visor.

This projecting rim 22, preferably rigid and formed in one piece with all or part of the front face 21a of the cap 21, includes a cut-out 23 forming a reading window coming to be positioned facing at least one of the markers 11 carried by the peripheral region 10 of the rotary control member 5, such as a rotary handwheel, that is to say by the ring 12 from FIG. 3, so as to enable a user to view this marker 11 through the reading window 23, which marker 11 represents a given gas flow rate value.

The cut-out 23 serving as a reading window therefore constitutes a notch arranged in the projecting rim 22.

When the rotary control member 5 is rotated by the user, one of the markers 11 comes to be positioned in front of the opening or notch formed by the cut-out 23 made in the projecting rim 22, which enables a user immediately and easily to read the flow rate indication that the corresponding marker 11 gives, with no risk of error since the reading window consisting of the cut-out 23 allows one and only one complete, that is to say non-truncated, marker 11 to appear.

The notch formed by the cut-out 23 is formed in the projecting rim 22 and can take different shapes, notably a U-shape with a rounded or flat bottom, a V-shape or any other similar or equivalent shape.

The projecting rim 22 forming a “visor” has a maximum width between 0.8 and 10 cm, preferably less than 7 cm, measured between the external edge or extremity of the projecting rim 22 and the junction of the projecting rim 22 and the body of the protective cap 21. In a similar way, the cut-out forms a notch extending to a depth between 0.5 and 5 cm in the projecting ring 22, as shown in FIG. 1.

The projecting rim 22 also makes it possible to protect the handwheel 5 if the bottle 20 is dropped onto its front face 21b.

Moreover, the projecting rim 22 includes one or more markings 25, for example an arrow or arrows and/or symbols “+” and/or “−”, representative of the direction in which the user must rotate the rotary control member 5 to increase and/or to decrease the gas flow rate delivered by the valve assembly 1, that is to say the clockwise or anticlockwise direction. This marking or these markings 25 are carried by the upper surface of the projecting rim 22 as shown in FIG. 1.

A system in accordance with the invention is particularly suitable for use in a medical environment, and is in particular suitable for storing any medical gas or gas mixture, in particular of oxygen, air, N₂O/O₂, He/O₂, NO/nitrogen or other type.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A gas distribution system including a gas container (20), a valve assembly and a protective cap (21) arranged around said valve assembly (1), and wherein:
the gas distribution valve assembly includes a rotary control member (5), manoeuvrable by a user, cooperating with a gas flow rate control system for controlling the gas flow rate delivered by the valve assembly, said rotary control member including a peripheral region (10) including markers (11) angularly offset relative to the rotation axis (AA) of the rotary control member, said markers (11) each corresponding to a given gas flow rate, and
the protective cap (21) including an opening (24) in which the rotary control member (5) is housed, wherein the opening (24) is at least in part bordered by a projecting rim (22) projecting away from the external lateral surface of the protective cap (21), said projecting rim (22) including a cut-out (23) forming a reading window coming to be positioned facing a marker (11) carried by the peripheral region (10) of the rotary control member (5) so as to enable a user to view said marker (11) through the reading window (23).

2. The Distribution system according to claim 1, wherein the opening (24) is at least in part bordered by a projecting rim (22) projecting away from the external lateral surface of the front face (21a) of the protective cap (21).

3. The Distribution system according to claim 1, wherein the markers (11) of the rotary control member (5) include increasing flow rate indications.

4. The Distribution system according to claim 1, wherein the markers (11) of the rotary control member (5) include increasing flow rate indications between 0 and 40 l/min, preferably between 0 and 25 l/min.

5. The Distribution system according to claim 1, wherein the gas outlet orifice (6) is carried by a gas outlet connector (15), the rotary control member (5) being mobile in rotation about said gas outlet connector (15).

6. The Distribution system according to claim 1, wherein the rotary control member (5) is a rotary handwheel.

7. The Distribution system according to claim 1, wherein the opening (24) is in the front face (21a) of the protective cap (21).

8. The Distribution system according to claim 1, wherein the projecting rim (22) includes one or more markings (25) representative of the direction in which the user must rotate the rotary control member (5) to increase or to decrease the gas flow rate delivered by the valve assembly (1).

9. The Distribution system according to claim 1, wherein the projecting rim (22) includes one or more markings (25) symbolizing at least one “arrow”, a “+” sign or a “−” sign.

10. The Distribution system according to claim 1, wherein the projecting rim (22) includes a cut-out (23) forming a reading window coming to be positioned facing a single marker (11) carried by the peripheral region of the rotary control member (5) so as to enable a user to view completely through said reading window (23) only said marker (11).

11. The Distribution system according to claim 1, wherein the cut-out (23) carried by the projecting rim (22) is a U-shaped or V-shaped notch.

12. The Distribution system according to claim 1, wherein cut-out (23) forms a notch in the projecting rim (22).

13. The Distribution system according to claim 1, wherein the cut-out (23) forms a notch extending to a depth between 0.5 and 5 cm in the projecting rim (22) and/or the projecting rim (22) has a maximum width between 0.8 and 10 cm.

14. The Distribution system according to claim 1, wherein the protective cap further includes a carrying handle connected to the cap by one or more support-uprights and an attachment device, adapted to enable the system to be attached to a support.
